(19) United States
(12) Patent Application Publication
(10) Pub. No.: US 2019/0347933 A1
(43) Pub. Date: Nov. 14, 2019

(54) METHOD OF IMPLEMENTING AN INTELLIGENT TRAFFIC CONTROL APPARATUS HAVING A REINFORCEMENT LEARNING BASED PARTIAL TRAFFIC DETECTION CONTROL SYSTEM, AND AN INTELLIGENT TRAFFIC CONTROL APPARATUS IMPLEMENTED THEREBY

(71) Applicant: Virtual Traffic Lights, LLC, Pittsburgh, PA (US)

(72) Inventors: Rusheng Zhang, Pittsburgh, PA (US); Akihiro Ishikawa, Mountain View, CA (US); Ozan K. Tonguz, Pittsburgh, PA (US)

(21) Appl. No.: 16/408,930

(22) Filed: May 10, 2019

Related U.S. Application Data
(60) Provisional application No. 62/670,410, filed on May 11, 2018.

(51) Int. Cl. G08G 1/08; G08G 1/081; G08G 1/065; G08G 1/01

(52) U.S. Cl. CPC G08G 1/08; G08G 1/081; G06N 20/00; G08G 1/0129; G08G 1/065

(57) ABSTRACT

A method of implementing an intelligent traffic control apparatus comprising providing a traffic control apparatus with a reinforcement learning based control system for a given traffic location; training the reinforcement based control system for the given traffic location on a simulator that simulates the given traffic location in a training environment, wherein the reinforcement learning based control system receives only partial traffic detection in the training environment on the simulator; and coupling the reinforcement learning based control system to the traffic control apparatus at the given traffic location after training. Specifically, the reinforcement learning based control system to the traffic control apparatus can function with improved results over current controls when less than 80%, and generally at least 5%, of vehicles are detected. Distributed independent or interconnected traffic control apparatuses may be implemented as well as a centralized system with multiple intelligent traffic control apparatus.

### RELATED APPLICATIONS

The present application claims the benefit of U.S. Provisional Patent Application Ser. No. 62/670,410 filed May 11, 2018 and titled “Traffic Control Apparatus Implementing Simulator Trained Artificial Intelligence Based Partially Detected Traffic Control System and Method of Implementing the Same” which is incorporated herein by reference in its entirety.

### BACKGROUND OF THE INVENTION

### Field of the Invention

We, Ozan K. Tonguz, Rusheng Zhang, and Akihiro Ishikawa have developed the present invention for the applicant Virtual Traffic Lights, LLC, which pertains to a traffic control, and, in particular, the present invention pertains to a method of implementing an intelligent traffic control apparatus having a reinforcement learning based partial traffic detection control system, and the intelligent traffic control apparatus implemented thereby.

### Background Information

Traffic congestion is a daunting problem that affects the daily lives of billions of people in most countries across the world. This is highlighted in the Department of Transportation report Traffic congestion and reliability: Trends and advanced strategies for congestion mitigation, https://ops.fhwa.dot.gov/congestion_report/executive_summary.htm, which is incorporated herein by reference. In the past 30 years, many different approaches to alleviate this problem have been proposed including a number of intelligent traffic control apparatuses.

A traffic control apparatus within the meaning of the present application may be defined as a signaling device controlling traffic flow, generally at intersections, although not exclusively as traffic control apparatuses can also be found at pedestrian crossings, merge points and other locations. These are commonly called traffic lights, but are also known as traffic signals, traffic lamps, traffic semaphores, signal lights, stop lights and traffic control signals and other variations of these and similar terms, which may be used interchangeably herein. Traffic control apparatus have a long history with a manually operated gas lit signal first being installed in London in December 1863, which unfortunately exploded less than a month later injuring the operator. Over the next 150+ years, traffic control apparatus technology advanced considerably. For example, modern intelligent traffic control apparatus can have artificial intelligence based control systems to optimize operation.

An intelligent traffic control apparatus can be considered part of an intelligent transportation system (ITS) that has been defined as an advanced application which aims to provide innovative services relating to different modes of transport and traffic management and enable users to be better informed and make safer, more coordinated, and smarter use of transport networks. Although ITS may technically refer to all modes of transport, the directive of the European Union 2010/40/EU defined ITS as systems in which information and communication technologies are applied in the field of road transport, including infrastructure, vehicles and users, and in traffic management and mobility management, as well as for interfaces with other modes of transport. ITS may improve the efficiency of transport in a number of situations, i.e. road transport, traffic management, mobility, etc.

Some prior art intelligent traffic control apparatus use real time traffic information measured or collected by video cameras or loop detectors and optimize the cycle split of a traffic control apparatus accordingly. Unfortunately, such known commercial intelligent traffic control schemes are expensive and, therefore, they exist only at a small percentage of intersections in the USA, Europe, and Asia.

Some intelligent traffic control apparatus implement reinforcement learning (RL) in their control systems, which is an area of artificial intelligence and machine learning concerned with how software agents ought to take actions in an environment so as to maximize some notion of cumulative reward. Reinforcement learning is considered as one of three machine learning paradigms, alongside supervised learning and unsupervised learning. Reinforcement learning, due to its generality, is studied in many other disciplines, such as game theory, control theory, operations research, information theory, simulation-based optimization, multi-agent systems, swarm intelligence, statistics and genetic algorithms. In the operations research and control literature, reinforcement learning is called approximate dynamic programming, or neuro-dynamic programming. The problems of interest in reinforcement learning have also been studied in the theory of optimal control, which is concerned mostly with the existence and characterization of optimal solutions, and algorithms for their exact computation, and less with learning or approximation, particularly in the absence of a mathematical model of the environment. One type of reinforcement learning is known as deep reinforcement learning (DRL) and this approach extends reinforcement learning generally by using a deep neural network and without explicitly designing the state space. It has been noted that the work on learning ATARI games by Google's DeepMind increased attention to deep reinforcement learning.

Recently, deep reinforcement learning for traffic control systems of traffic control apparatus has been explored and the results obtained have been reported by several groups. For example, note Wade Genders and Saiedeh Razavi, Using a deep reinforcement learning agent for traffic signal control, arXiv preprint arXiv:1611.01142, 2016; and Elise van der Pol, Deep reinforcement learning for coordination in traffic light control, PhD thesis, Master's Thesis. University of Amsterdam, 2016, which results are incorporated herein by reference. These results show an improvement in terms of waiting time and queue length experienced at an intersection; however, these results are based on full observation of traffic.

Reinforcement learning, including DRL, for traffic control systems for traffic control apparatus may still be considered as a new field at its infancy, as the algorithms as well as state and reward representations are still under-explored, but can still yield improved results. The Genders et al. research cited above, proposed a new discrete traffic state encoding (DTSE) and trained a Deep Q-Network (DQN) agent with convolutional layers with experience replay, wherein DTSE is composed of a vector of presence of vehicles, speed of vehicles, and current traffic signal phase. A Deep Q-Network (DQN) agent may be described as a value-based reinforcement learning agent that trains a critic to estimate the return or future rewards. The Genders et al. research reported significant improvement over one hidden layer NN control agent.

The research of Artificial Intelligence (AI), especially using reinforcement learning (RL) on traffic control systems for traffic control apparatus, has actually attracted a lot of interest for a long time. In 1994, Mikami, et al. proposed distributed reinforcement learning (Q-learning) using a Genetic Algorithm to present a traffic control scheme that effectively increased the throughput of the traffic network. See Mikami, Sadayoshi, and Yukinori Kakazu, Genetic reinforcement learning for cooperative traffic signal control, Evolutionary Computation, 1994. Due, at least in part, to the limitations of computational power in 1994, such scheme was not implementable at that time.

Recently, several new results on this topic have been published as the RL approach has matured for commercial use. Bingham proposed RL for parameter search of a fuzzy-neural traffic control system for traffic control apparatus for a single intersection {See Bingham, Ella, Reinforcement learning in neurofuzzy traffic signal control, European Journal of Operational Research131.2 (2001): 232-241} while Choy et al. adapted RL on the fuzzy-neural system in a cooperative scheme, achieving adaptive control for a large area {Choy M C, Srinivasan D, Cheu R L. Hybrid cooperative agents with online reinforcement learning for traffic control, InFuzzy Systems, 2002. FUZZ-IEEE'02. Proceedings of the 2002 IEEE International Conference on 2002 (Vol. 2, pp. 1015-1020). IEEE}. These traffic control system algorithms are based on RL and are incorporated herein by reference. A major goal of RL may be, in this context, described as parameter tuning of the fuzzy-neural system.

Abdulhai et al. proposed the first true adaptive intelligent traffic control apparatus which learns to control the traffic dynamically based on a Cerebellar Model Articulation Controller (CMAC) based control system, as a Q-estimation network {Abdulhai B, Pringle R, Karakoulas GJ, Reinforcement learning for true adaptive traffic signal control, Journal of Transportation Engineering. 2003 May; 129(3):278-85}. Da Silva, et. al. {da Silva, ALCB Bruno Castro, Denise de Oliveria, and E. W. Basso, Adaptive traffic control with reinforcement learning, Conference on Autonomous Agents and Multi-agent Systems (AAMAS). 2006} and Oliveira et. al. {de Oliveira, Denise, et al., Reinforcement Learning based Control of Traffic Lights in Non-stationary Environments: A Case Study in a Microscopic Simulator EUMAS. 2006} then proposed a context-detector (CD) in conjunction with RL in the control system of an intelligent traffic control apparatus to further improve the performance under non-stationary traffic situations, and these control protocols or algorithms are incorporated herein by reference.

Several researchers have focused on multi-agent reinforcement learning for implementing intelligent traffic control apparatus at a large scale {Abdoos, Monireh, Nasser Mozayani, and Ana LC Bazzan, Traffic light control in non-stationary environments based on multi agent Q-learning, Intelligent Transportation Systems (ITSC), 2011 14th International IEEE Conference on. IEEE, 2011}, {Medina, Juan C., and Rahim F. Benekohal, Traffic signal control using reinforcement learning and the max-plus algorithm as a coordinating strategy, Intelligent Transportation Systems (ITSC), 2012 15th International IEEE Conference on. IEEE, 2012}, {El-Tantawy, Samah, Baher Abdulhai, and Hossam Abdelgawad Multiagent reinforcement learning for integrated network of adaptive traffic signal controllers (MARLIN-ATSC): methodology and large-scale application on downtown Toronto, IEEE Transactions on Intelligent Transportation Systems 14.3 (2013): 1140-1150} and {Khamis, Mohamed A., and Walid Gomaa Adaptive multi-objective reinforcement learning with hybrid exploration for traffic signal control based on cooperative multi-agent framework Engineering Applications of Artificial Intelligence29 (2014): 134-151. Recently, with the development of GPU and computation power, Deep Reinforcement Learning has become an attractive method in several fields. Several attempts have been made using 0-learning for a Deep Q-Network (DQN), including Genders et al and Elise van der Pol cited above (see also {van der Pol, Elise, et al. Video Demo: Deep Reinforcement Learning for Coordination in Traffic Light Control, BNAIC. Vol. 28. Vrije Universiteit, Department of Computer Sciences, 2016}. These results, incorporated herein by reference show the general state of the art and establish that a DQN based Q-learning algorithm is capable of optimizing the traffic flow in an intelligent traffic control apparatus.

Recently, a more cost effective approach to implementing intelligent traffic control apparatus was proposed by leveraging the fact that the Dedicated Short-Range Communication (DSRC) technology will be mandated by US Department of Transportation (DoT) and will be implemented in the near future. DSRC technology is potentially a much cheaper technology for detecting the presence of vehicles on the, typically, four approaches of an intersection. However, at the early stages of deployment, only a small percentage of vehicles will be equipped with DSRC radios. This early stage can last several years due to the increasing vehicle life {see Average age of cars on U.S. roads breaks record. https://www.usatoday.com/story/money/2015/07/29/new-car-sales-soaring-but-cars-getting-older-too/}. Control algorithms that can only function based exclusively upon detection of DSRC-equipped vehicles becomes a solution that cannot be implemented for an extended period.

All the aforementioned research, however, focus on the traditional intelligent traffic systems (ITS), mostly with loop/camera detectors, where all vehicles are detected. However, even though RL approach yields impressive results for these cases, it does not outperform current systems. Hence, the development of these algorithms, while useful, is of limited real world significance, since there already exist a lot of ITS systems that perform reasonably well.

It is an object of the present invention to overcome the deficiencies of the prior art and provide intelligent traffic control apparatus with traffic control system algorithms that can function effectively in real world conditions.

### SUMMARY OF THE INVENTION

The object of the present invention is achieved according to one embodiment of the present invention by a method of implementing an intelligent traffic control apparatus comprising the steps of: providing a traffic control apparatus with a reinforcement learning based control system for a given traffic location; training the reinforcement based control system for the given traffic location on a simulator that simulates the given traffic location in a training environment, wherein the reinforcement learning based control system receives only partial traffic detection in the training environment on the simulator; and coupling the reinforcement learning based control system to the traffic control apparatus at the given traffic location after training. The invention yields new traffic control algorithms that can function by partial detection of vehicles, such as DSRC-equipped vehicles.

The object of the present invention is achieved according to one embodiment of the present invention by an intelligent traffic control apparatus comprising a traffic control apparatus for a given traffic location; and a reinforcement learning based control system coupled to the traffic control apparatus at the given traffic location, where the reinforcement based control system is trained for the given traffic location on a simulator that simulates the given traffic location in a training environment, and wherein the reinforcement learning based control system receives only partial traffic detection in the training environment on the simulator.

One aspect of the present invention provides a traffic control apparatus that implements a simulator trained, artificial intelligence based, partially detected traffic control system. Specifically, a reinforcement learning (RL) based traffic control system for implementing an intelligent traffic system can function when less than 80%, and generally at least 5%, of vehicles equipped with On-Board Units (transceivers) are detected.

The method of implementing an intelligent traffic control apparatus according to one aspect of the invention provides that the reinforcement learning based control system detects at least about 5% of the traffic in the training environment on the simulator. The reinforcement learning based control system may detect up to about 80% of the traffic in the training environment on the simulator. The reinforcement learning based control system may detect up to about 60% in the training environment on the simulator.

The method of implementing an intelligent traffic control apparatus according to one aspect of the invention may provide wherein the reinforcement learning based control system includes an absolute minimum and maximum phase time for the traffic control apparatus in at least one or in each phase of the traffic control apparatus.

The method of implementing an intelligent traffic control apparatus according to one aspect of the invention may provide wherein following coupling the reinforcement learning based control system to the traffic control apparatus at the given traffic location after training the reinforcement learning based control system maintains a control algorithm developed in the training.

The method of implementing an intelligent traffic control apparatus according to one aspect of the invention may provide wherein the reinforcement learning based control system controls the traffic control apparatus at the given traffic location based only on the traffic location's traffic condition.

The method of implementing an intelligent traffic control apparatus according to one aspect of the invention may provide wherein the reinforcement learning based control system of the traffic control apparatus at the given traffic location is coupled to at least one other reinforcement learning based control system of a traffic control apparatus at another traffic location.

The method of implementing an intelligent traffic control apparatus according to one aspect of the invention may provide wherein the reinforcement learning based control system is associated with multiple traffic control apparatus at several given locations wherein the training of the reinforcement based control system is for the multiple traffic locations on a simulator and wherein the coupling of the reinforcement learning based control system is to the multiple traffic control apparatus at the multiple traffic location after training.

The method of implementing an intelligent traffic control apparatus according to one aspect of the invention may provide wherein the reinforcement learning based control system is a Deep Q-Network.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

The features that characterize the present invention are pointed out with particularity in the claims which are part of this disclosure. These and other features of the invention, its operating advantages and the specific objects obtained by its use will be more fully understood from the following detailed description and the operating examples.

### BRIEF DESCRIPTION OF THE FIGURES

FIG. 1 is a schematic representation of intelligent traffic control apparatuses implementing a Partially Detected Traffic System type control system according to one aspect of the present invention;

FIG. 2 is reinforcement learning as it is implemented in a reinforcement learning control system of the present invention;

FIG. 3 is a schematic block diagram of reinforcement learning based control system's strategy using Q learning according to the principles of the present invention;

FIGS. 4 A and 4B are schematic state representations of two different phases of a simulated intersection for a traffic control algorithm of the reinforcement learning based control system according to one aspect of the present invention;

FIG. 5 is a schematic illustration of method of implementing an intelligent traffic control apparatus in accordance with one embodiment of the present invention;

FIG. 6 schematically illustrates a distributed intelligent traffic control apparatus system according to one embodiment of the present invention deployed on the two intersections;

FIG. 7 schematically illustrates a centralized intelligent traffic control apparatus system according to one embodiment of the present invention deployed on the two intersections;

FIG. 8 shows the performance of a reinforcement learning based control system according to one embodiment of the present invention during the training;

FIG. 9 is a chart of average waiting time under different penetration rates with medium arrival rate of a reinforcement learning based control system of the present invention and alternative control systems;

FIG. 10 is a chart of average waiting time under different penetration rates with sparse arrival rate of a reinforcement learning based control system of the present invention and alternative control systems;

FIG. 11 is a chart of average waiting time under different penetration rates with dense arrival rate of a reinforcement learning based control system of the present invention and alternative control systems; and

FIG. 12 is a chart of average waiting time under different penetration rates at medium car flow of the reinforcement learning based control system of the present invention implemented on a 5×1 Manhattan Grid.

### DESCRIPTION OF THE PREFERRED EMBODIMENTS

Currently, with the rapid development of wireless communication and applications in vehicular networks, several new kinds of technologies for intelligent traffic systems have emerged, such as the DSRC based vehicle detection/communications for use in intelligent traffic system discussed above. Additionally BLE 5.0, UWB, RFID, Wifi or other wireless technology based vehicle detection, and vehicle to cloud (V2C) based detection, RFID based, Zigbee, and even cellphone apps, such as google maps based detection for intelligent traffic systems are also known.

All these vehicle detection systems have several advantages, such as: they can detect more information such as speed, position and history path; they detect vehicles in a continuous manner; and most importantly, the cost of such systems is generally much cheaper than alternatives. However, one of the biggest drawbacks of all these systems is that it is hard, if not impossible, to equip all of the vehicles on the road with a device so that they can be detected. In fact, most of these systems will probably be deployed with a low detection rate, especially at the beginning of their deployment.

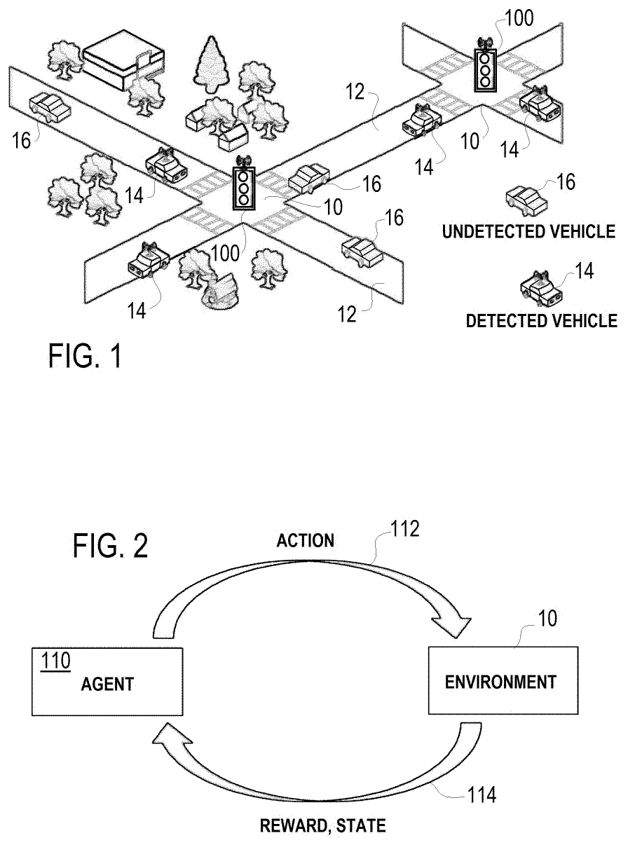

The present invention utilizes a concept called (herein) Partially Detected Traffic System (PDTS), which yields a traffic control system that performs based on feedback from an incomplete detection of traffic situation. This terminology is a coined term and may best be illustrated in FIG. 1. The invention described below yields a RL based algorithm that will perform reasonably well under low penetration rates, and provide advantageous traffic control systems during the transition from the low detection rates to high detection rates.

FIG. 1 is a schematic representation of intelligent traffic control apparatuses 100 implementing a Partially Detected Traffic System type control system 110 (described below) according to one aspect of the present invention wherein the system 110 detects some vehicles 14 (those equipped with relevant detection technologies) and not other vehicles 16. The intelligent traffic control apparatuses 100 comprises a traffic control apparatus or signaling device 140 for a given traffic location 10. The locations 10 shown in FIG. 1 are intersections which are most common, but any roadway location is possible, such as cross walks, merge points or many other locations. The intelligent traffic control apparatuses 100 includes a reinforcement learning based control system 110 coupled to the traffic control apparatus 140 at the given traffic location 10. The traffic control apparatus 140 may be considered as the traffic light itself while the intelligent traffic control apparatuses 100 includes the control system 110. The Partially Detected Traffic System type control system 110, also called the reinforcement based control system 110 (or agent 110 in reference to common reinforcement parlance), is trained for the given traffic location 10 on a simulator 120 that simulates the given traffic location 10 in a training environment, and wherein the reinforcement learning based control system 110 receives only partial traffic detection in the training environment on the simulator 120.

Q Learning Algorithm:

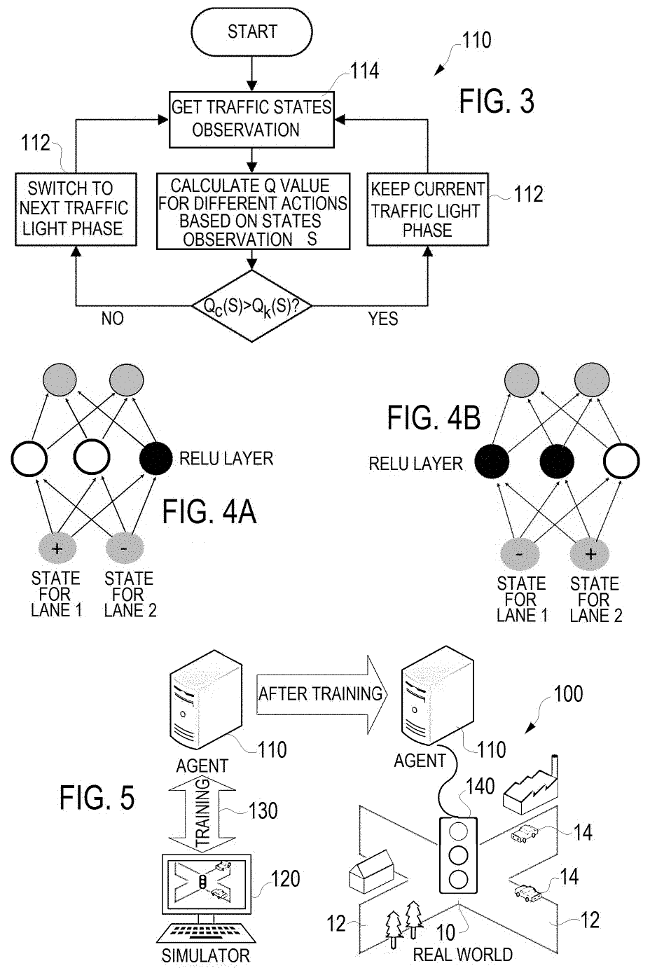

The goal of a reinforcement learning algorithm is to train an agent, in this case the system 110, which interacts with the environment by selecting the action 112 in a way that maximizes the future reward 114. As shown in FIG. 3, at every time step, the agent (or system 110) gets the state (the current observation of the environment) and reward information (the quantified indicator of performance from the last time step), collectively 114, from the environment and chooses a correct action 112. During this process, the agent (system 110) tries to optimize (maximize/minimize) the cumulative reward 114 for its action policy. The beauty of this kind of algorithm is the fact that it doesn't need any supervision, since the agent (system 110) observes the environment and tries to optimize its performance without human intervention.

One such algorithm is known as Q-learning as described in Christopher J. C. H. Watkins and Peter Dayan, Q-learning. Machine Learning, 8(3):279-292, May 1992. Q-learning enables an agent 110 to learn to act optimally in finite Markovian domains. In the Q-learning approach, the agent 110 maintains a so-called ‘Q-Value’, denoted as Q(⋅), which is a function with input of observed state sₜ and action aₜ and output of the cumulative reward rₜ. Here, t denotes the discrete time index. The cumulative reward is defined as:

Q(sₜ,aₜ)=rₜ+γrₜ₋₁+γ²rₜ₋₂+γ³rₜ₋₃+γⁱrₜ₋ᵢ+ . . .

Here, γ<1 is a design parameter that depends on how much the user cares about future reward. If the user cares about the future reward a lot, γ should be closer to 1 to make γⁱ decay slower. At every step, the agent 110 updates its Q function by an update of the Q value:

Q(sₜ,aₜ)=Q(sₜ,aₜ)+α(rₜ₊₁+γ max Q(sₜ₊₁,aₜ)−Q(sₜ,aₜ))

In most of the cases, including the traffic control scenarios of interest, due to the complexity of the state space and action space, deep neural networks in the system 110 can be used to approximate the Q function. Instead of updating the Q value, the value may be as follows:

Q(sₜ,aₜ)+α(rₜ₊₁+γ max Q(sₜ₊₁,aₜ)−Q(sₜ,aₜ))

as the output target of the Q network of system 110 and do a step of back propagation on the input of sₜ, aₜ.

In addition, to stabilize the learning, target Q network, and an on-line Q network were maintained. Target Q network is used to approximate the true Q values, and the on-line Q network returns the Q values given agent's state and action. Target Q network's weights are synchronized at every certain interval. Also, instead of training after every step an agent 110 has taken, past experience was stored in a memory buffer and training data was sampled from the memory for a certain batch size. This experience replay aims to break the time correlation between samples.

In a preferred embodiment of the invention, training of the traffic light agent 110 uses a Deep Q-Network (DQN). For further background see Volodymyr Mnih, Koray Kavukcuoglu, David Silver, Andrei A. Rusu, Joel Veness, Marc G. Bellemare, Alex Graves, Martin Riedmiller, Andreas K. Fidjeland, Georg Ostrovski, Stig Pe-tersen, Charles Beattie, Amir Sadik, loannis Antonoglou, Helen King, Dharshan Kumaran, Daan Wierstra, Shane Legg, and Demis Hassabis, Human-level control through deep reinforcement learning, Nature, 518(7540):529-533, February 2015. Since the general algorithm is well-defined, the invention herein focuses on the action 112 of the agent 110 and on correctly assigning the state and rewards 114.

Parameter Modeling

Agent 110 Action:

The present invention concerns a method of implementing an intelligent traffic control apparatus 100 having a reinforcement learning based partial traffic detection control system 110, and the intelligent traffic control apparatus 100 implemented thereby. The reinforcement learning based partial traffic detection control system 110 takes rewards and state observation 114 (which are defined further below) from the environment and chooses an action 112. In this context, the relevant action of the agent 110 is either to keep the current traffic light phase, or to switch to the next traffic light phase. Every time step, the agent 110 makes an observation and takes action 112 accordingly, thus achieving smart or intelligent control of traffic.

3 shows the block diagram of the behavior of the system 110. As shown in the figure, the agent 110 observes the traffic state S at each time step at 114. Based on S, it computes the Q-value of different actions 112. In this case, there are two possible actions 112: keep in the current phase associated with value Qₖ(S), or switch to the next phase associated with the value Q_{c}(S). If Qₖ(S) is smaller, it will keep the current phase; otherwise, it will switch to the next phase

Reward:

For traffic optimization problem, the goal is to decrease the average traffic delay of commuters 14, 16 in the network (at the intersection 10). Namely, find the best strategy S. such that tₛ−tₘᵢₙ is minimum, where tₛ is the average travel time of commuters in the network, under the traffic control scheme and tₘᵢₙ is the physically possible lowest average travel time. Consider traveling the same distance d, d=∫₀^{t}^{ₛ}vₛ (t′) dt=tₘᵢₙvₘₐₓ. Hence,

$${t}_{s} - {t}_{min} = \frac{1}{{v}_{max}} {\int }_{0}^{{t}_{s}} {v}_{max} - {v}_{s} ( t ) dt$$

Therefore, to get minimum travel delay is equivalent to minimizing at each time step:

$$\frac{1}{{v}_{max}} [ {v}_{max} - {v}_{s} ]$$

Hence, the system 110 chooses this value as the reward of each time step.

State Representation:

Considering that the computational power is limited, the state representation has to be carefully addressed. In order to make the learning process a Markov Decision Process (MDP), the state should contain information of traffic process as much as possible. In the context of partially detected traffic control systems 110 of the invention, only a portion of the vehicles 14 are detected (vehicles 16 in FIG. 1 represent undetectable vehicles), but usually, more specific information about these vehicles 14 such as speed, position are given as opposed to that information found in current or traditional intelligent traffic systems (ITS), which usually only give presence of the vehicles 14. In a preferred embodiment of the present invention the nearest vehicle 14 at each approach, number of vehicles 14 at each approach, the current traffic light phase for the apparatus 100, and current traffic light phase elapsed time are collectively chosen as the components of the state.

Instead of using an extra dimension to describe current phase, to make DQN network easier to be trained, the present invention uses the sign of other dimensions to do so. For example if lane 1 is green, all the status about lane 1 (number of cars 14, distance of nearest vehicles 14, etc) is positive, otherwise negative. The benefit of such representation is that, since the invention is using Rectified Linear Unit (ReLU) activation, it will automatically enable/disable certain hidden units under different traffic phase. In this way, the same unit will only be activated for one phase. Namely, the unit used to calculate Q value is completely separated for different phase. 4A and 4B illustrate the benefit of using this state representation in a simple example. Here is considered a case when there are only two lanes approaching the intersection, lane 1 and lane 2, respectively. The Q-network of system 110 in this example is also simplified as a 3 layer network. The input is 2-dimension, while the first component is the number of vehicles in the first lane and the second component is the number of vehicles in the second lane. The network takes the input value, calculates through the hidden layer containing 3 units and outputs the Q value of two possible actions. 4A shows the case when lane 1 gets a green. In this case, the first input unit will be positive and the second input unit will be negative. In the hidden layer, after ReLU activation, the neurons of positive pre-activation will be activated and those of negative pre-activation will not be activated. As shown in FIG. 4A, the first and second hidden units are activated (shown in open) and the third is not. Meanwhile, 4B shows the case when lane 2 gets a green. In this case, the first input component will be negative and the second will be positive. With the same weights, the pre-activation of the neural network will have exactly the opposite number of the case shown in 4A. Hence, the first and second neurons will have negative pre-activation, and will not be activated in this case while the third neuron will be activated. In this way, different hidden states will be activated for different traffic phase states. Hence, the weights used to compute the Q value of different traffic light phases will be completely separated. Thus FIGS. 4A and 4B schematically represent state representation of two different phase, notice that ReLU activation only activate when it's positive, none of the hidden layer will be activated in both phase.

Concluding from the above discussion, the final state representation only has 10 dimensions. The state contains the number of (detected) vehicles 14 in each approach, the distance of the nearest vehicle 14 in each approach, the elapsed time of the phase and a yellow phase indicator, which is 1 if the phase is yellow, otherwise 0. For example, an intersection with 4 approaches, with the number of cars 14 on each approach 2,3,3,5, respectively; the distance of the nearest vehicles at each approach are 5 m, 10 m, 6 m, 15 m respectively; currently lane 1 and lane 3 are having green phase for 11 seconds, the state representation will be [2, −3, 3, −5 5 −10, 6, −15, 11, 0].

System Design

In this section, the method of implementing an intelligent traffic control apparatus is further described and schematically represented in FIG. 5. The method can be summarized as providing a traffic control apparatus 100 with a reinforcement learning based control system 110 for a given traffic location 10; training 130 the reinforcement based control system 110 for the given traffic location 10 on a simulator 120 that simulates the given traffic location 10 in a training environment, wherein the reinforcement learning based control system 110 receives only partial traffic detection in the training environment on the simulator 120; and coupling the reinforcement learning based control system 110 to the traffic control signaling device or apparatus 140 to form the intelligent traffic control signaling device 100 at the given traffic location 10 after training. The implementation of the system contains two phases, the training phase 130 and the performing phase. As shown in FIG. 5, the agent 110 is first trained with a simulator 120. After the training 130 is done, it is then ported to the intersection 10, connected to the real traffic signal 140, after which the apparatus 100 starts to control the traffic.

Training Phase

First of all, the agent 110 is trained by interacting with a traffic simulator 120. The simulator 120 simulates the arrivals of vehicles 14, 16 at the intersection 10, and determine if the vehicle 14, 16 can be detected (14) based on a Bernoulli distribution with parameter p. The parameter p is the detection rate. The present invention works for detection rates less than 100% (p<1). Significant results are achieved with the system of the present invention with detection rates as low as 5% (p=0.05). Thus any detection rate above 5% will yield meaningful results, but at detection rates above about 80% the distinctions in results of the present system and alternative systems become less noticeable in practice. The reference to “about a X %” detection rate will define herein +/−1% of the stated rate. Thus detection rates of about 5-80% become a practical operational parameters of the system of the present invention with a more advantageous range found at detection rates of about 5-60%. In the context of DSRC based vehicle detection system, the detection rate corresponds to the DSRC equipment penetration rate. Using the simulator 120, the training proceeds by obtaining the traffic state S, and then calculating the current reward rₜ accordingly, and feed it to the agent 110. The agent 110 updates based on the information from the simulator 120 and using the Q-learning updating formula discussed previously. Meanwhile, the agent 110 will choose an action 112 aₜ based on FIG. 3, and forward the action 112 to the simulator 120. The simulator 120 will then update, and change the traffic light phase according to agent's indication of action 112. These steps are done repeatedly until convergence, at which point the agent 110 is trained.

Performing Phase

The software agent 110 is then installed or coupled to the apparatus 140 at the intersection 10 for controlling the traffic light 140. Once installed, the agent 110 will not update its weight any more, but simply control the traffic signal 140. Namely, the detector of the system 110 will feed the agent 110 current detected traffic state sₜ; based on sₜ, the agent 110 chooses an action 112 according to FIG. 3 and controls the traffic signal 140 to switch/keep phase accordingly. This step is performed at each time step, thus enabling continuous traffic control.

Deployment Scheme

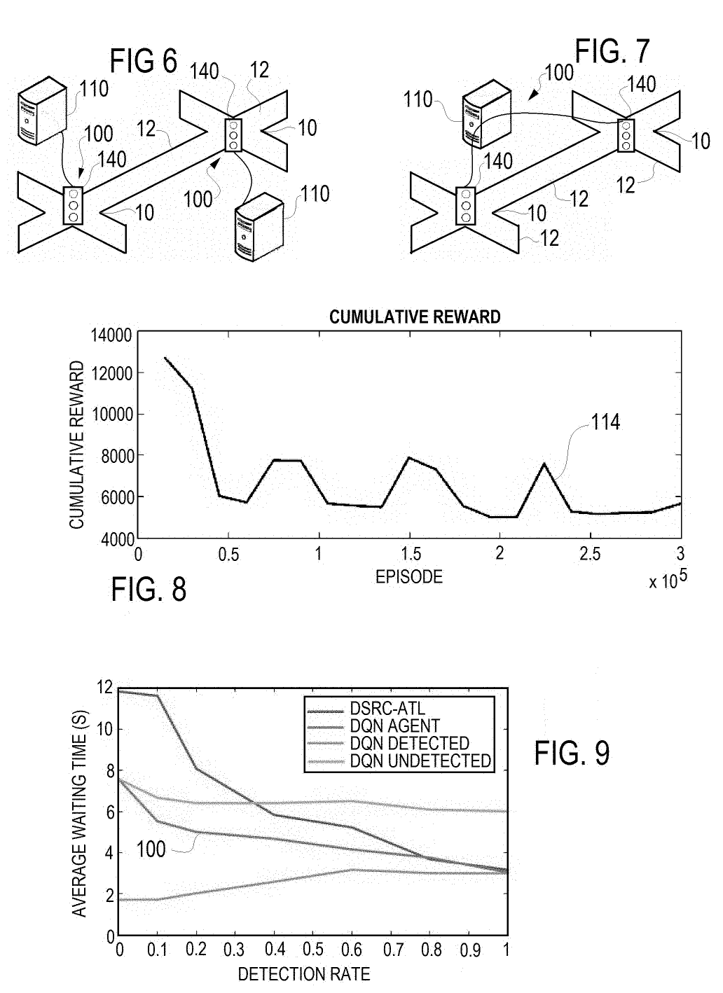

The present invention uses RL technology to handle traffic control in a partially detected traffic system. It is worth mentioning here that there can be several distributed system embodiments: i) A distributed system without communication between agents 110 shown in FIG. 6, where the agents 110 do the decision only based on that intersections' traffic condition. This applies to situations such as DSRC BSM, RFID, Bluetooth, and WiFi based traffic systems. ii) A distributed system with communication between agents 110, where each agent 110 makes decision based on both the detection and the behavior of other adjacent agents 110. This applies to situations such as to VANET based traffic system. This would look similar to FIG. 6 with communication between the illustrated systems 110. iii) A centralized system, where one agent 110 make decision for all the intersections 10, such as Google Map, LTE based Vehicle to Cloud (V2C) traffic system, and as represented in FIG. 7. Thus FIGS. 7 and 6 schematically show examples of centralized and distributed systems, respectively, deployed on the same two intersections.

### Examples

The present invention can be implemented using a SUMO simulator 120 For further details see Daniel Krajzewicz, Jakob Erdmann, Michael Behrisch, and Laura Bieker, Recent development and applications of sumo-simulation of urban mobility, International Journal On Advances in Systems and Measurements, 5(3&4), 2012. In summary this is a microscopic simulator 120 that is widely used by the transportation industry.

The Q-network used has two hidden layers with 512 hidden units each followed with ReLU activation. For all examples, the present invention trained a single traffic light agent 110 with state representation that was proposed for 150 episodes, where each episode consists of 3000 iterations (1 iteration is 1 second of simulation). The examples used learning rate of 0.0001, discount factor γ of 0.9, linearly decaying exploration rate down to 0.05 in 100,000 iterations, and batch size of 32. To make the environment realistic, and also easier to be trained, some constraints are added to the environment. First of all, the traffic light 140 has to conserve its phase for at least 5 seconds; namely, even when the agent 110 decides to switch phase within 5 seconds from the start of a phase, the request will be denied. This step will ensure that frequent toggling of traffic light 140 is avoided. Secondly, maximum phase time of 40 seconds is assigned, namely, if a certain phase is conserved for more than 40 seconds, the traffic light 1140 will switch to the next phase even the agent 110 does not decide to do so. In this way, the traffic light 140 is prevented from keeping the same phase for a long time. Between the phases switching, a yellow phase of 3 seconds is assigned. The absolute number of minimum and maximum phase time can be assigned freely based on the actual traffic condition, the numbers assigned herein agree with most of modern traffic control systems.

The vehicle arrival pattern follows a Poisson Process. Without loss of generality, different arrival rates are evaluated to show the performance under different conditions:
1. Sparse car flow: Sparse car 14, 16 flow corresponds to the cases such as mid-night or an intersection where very few cars 14, 16 arrive. The system of the invention used an arrival rate of 0.02 on each approach 12 of the intersection 10.
2. Medium car flow: Medium car 14, 16 flow corresponds to most of the intersections 10 during the non-rush hours. The invention choose different values on each approach 12 in this case, corresponding to real world. Here the arrival rate of the four approaches 12 are 0.2, 0.1, 0.05, 0.02 veh/s, respectively.
3. Dense car flow: Dense case corresponds to most of intersections 10 during rush hours. Since this example only considers single intersection 10, this example will keep the car flow under-saturated. The invention in this example choose the arrival rate of the 4 approaches to be 0.2, 0.2, 0.2, 0.2 veh/s, respectively.

Results and Discussion

Observation in Training Process

FIG. 8 shows the performance of an agent 110 during the training 130. An average reward per epoch was computed every 5 episodes during the training 130 using a greedy policy to see the performance trend of the agent 110. The trend of the reward 114 is going down (as desired) as shown in FIG. 8. In fact, the cumulative reward is decreased by half. This is impressive since a random strategy can already perform very well under this sparse arrival setting. By evaluating the performance directly from the GUI in SUMO simulator 120, it can be observed that the traffic light 140 acts based on the vehicles' arrival intelligently. This evidences the efficacy of the method of the present invention.

The training process 130 may also be recorded in as a video to directly show the effectiveness of the training 130. From the video as well, it can be demonstrated that the traffic control algorithm of the system 110 ‘evolves’ during time, from random movement to finally “understanding” the traffic control rules and how to lower the reward. After the training 130 is done, the traffic lights controlled by the system 110 react “intelligently” to the car 14, 16 flow and achieves smart control of the intersection 10.

Comparison with Other Traffic Control Schemes

In this section, the optimized agent 110 of the invention obtained from Deep Q learning is compared with some common traffic control agents:
1. Fixed time traffic light: for comparison a fixed time traffic light of 30 seconds per phase is used to compare with the result of the present invention. This is the case with most of current traffic lights
2. Random change of phase: For this comparative system, at each second, a 0.5 probability to change phases was given or used. This is actually the case when the system 110 first started the training 130.
3. DQN agent: This is the algorithm of the system 110 obtained by DQN trained during the reinforcement learning of the training 130.
4. Virtual Traffic Lights (VTL): For comparison the results of the invention are compared with another well-known smart traffic control system known as VTL.

The results under medium car flow with full detection (all cars 14 detected) are shown in the Table.1. From the table, it is shown that a fixed time agent will result in the cars 14 with average waiting time more than 13 seconds, while after optimization, the agent 110 only takes a little bit more than 3 seconds. The waiting time is reduced by 77.6%. This is very impressive as it achieves the same level of performance as VTL, which is also a little bit more than 3 seconds.

TABLE 1
Performance Comparison

| Algorithm | Average Waiting Time (s) |
|---|---|
| Fixed Time | 13.58 |
| Random Action | 13.71 |
| DQN agent | 3.04 |
| VTL | 3.16 |

Performance Under Partial Detection

Of course, a more interesting case is to evaluate the performance under partial detection rate, since the key aspect of the present invention is to utilize this algorithm for partial detection case; e.g., under only detecting DSRC vehicles 14. In this case, there is a comparison under three different car flow situations, as discussed in below. The DQN agent of system 110 was trained and tested under certain penetration rates. The initial training was on full penetration rate and to train the agent 110 for a lower penetration rate, the agent 110 was trained under that specific penetration rate with initial weight of higher penetration rate. The agent 110 was repeatedly trained with lowering the penetration rate until 0.

Medium Car Flow

The invention obtained the most typical results from medium car flow case, so this case is presented first. The result in waiting time is shown in FIG. 9. Here, a version of VTL, known as DSRC-Actuated Traffic Light (DSRC-ATL) is used for comparison. The overall waiting time of all cars in the simulation, including detected and undetected cars is also shown. Notice that while detection rate is high, the DQN agent of system 110 will perform at the same level of DSRC-ATL, however when the detection rate is low, the present invention yields significantly better performance with the DQN agent of system 110. This is due to the fact that the DQN agent 110 is trained to optimize the average waiting time; hence, at low detection rate, it will still work as an optimized pre-timed traffic light, as opposed to DSRC-ATL, which will work as an un-optimized traffic light at low detection rate.

It is also important to observe that the waiting time is reduced by more than 50% when the detection rate increases from 0% to 100%. This shows the value of detecting the vehicles 16. Notice that the curve is convex, meaning that the benefit of detected vehicles 16 is the biggest when the detection rate is lowest. In fact, 80% of the benefit occurs at 20% detection rate. Hence, reinforcement learning algorithm of system 110 gives an excellent solution for traffic optimization at low detection rates. This is very important during the transition period during which the proportion of DSRC-equipped vehicles will be small.

It is also worth mentioning that in the whole transition from 0% detection rate to 100% detection rate, the average waiting time of a detected vehicle 14 is always lower than the average waiting time of an undetected vehicle 16. From a business perspective, this provides a strong incentive for the transition process to move on. Let's take the DSRC-detection as an example: this trend will give people a strong incentive to equip their vehicles with DSRC equipment. This, in turn, helps promoting the transition to equipping vehicles with DSRC equipment. Another important observation here is that the benefit of the detected vehicle 14 does not hurt the performance of those undetected vehicles 16. In fact, in this example, a small decrease is observed in waiting time for even undetected vehicles 16 when detection rate gets higher. This gives a sense of “fairness” to the system, that the waiting time decrease is not derived from those undetected vehicles.

Sparse Car Flow

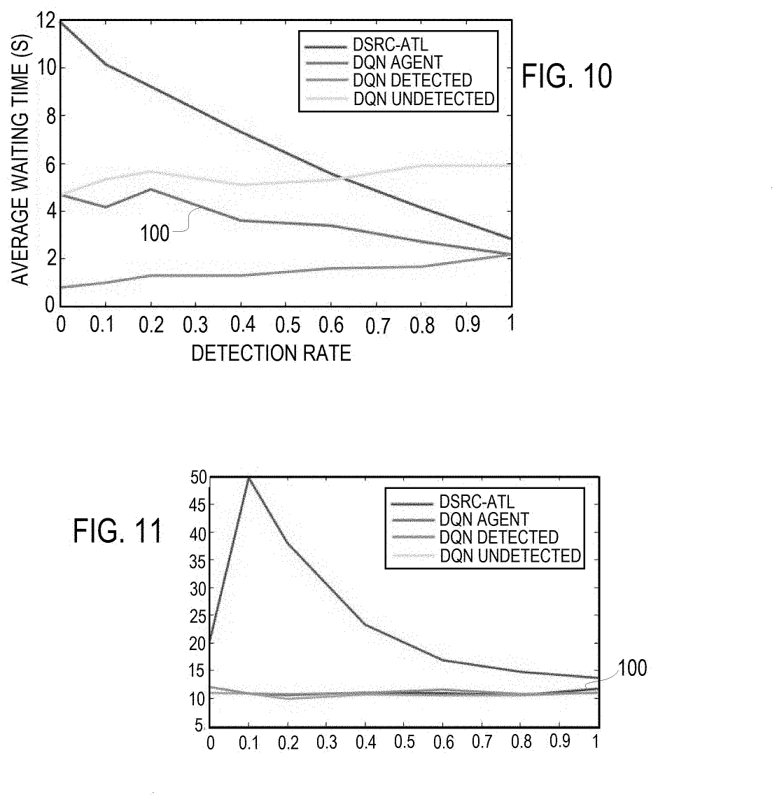

FIG. 10 shows the situation when car arrival is sparse. Observe that, in this case the overall trend is very similar to the results reported above. From the figure, it can be shown that the benefit of the present invention under low detection rate is not as significant as under medium arrival rates because of the fact that when arrival rate is very sparse, there is not a certain ‘pattern’ of the car flow that a traffic system can follow. Hence, in this case, the detected vehicle 14 will only contribute to its own proportion of the waiting time benefit, and the trend will become a “linear” trend. This confirms the fact that the convex shape in FIG. 9 is a result of the car flow pattern. Namely, the traffic system can use the car flow pattern to optimize traffic even without knowing all the arrival information of the vehicles 14, 16.

Though the behavior in this case is not as interesting as the medium flow case shown in FIG. 9 which has a nice convex shape, an asymptotically decreasing curve is still presented as a function of the penetration rate. Meanwhile, this is a scenario that only happens at midnight or at those very unpopular intersections. Hence, the performance curve shown in FIG. 10 is still acceptable.

Dense Car Flow

FIG. 11 shows the performance of system of the present invention when car flow is dense. In this situation, the performance is very different from the medium car flow in FIG. 9 and sparse car flow in FIG. 10. First, DSRC-ATL does NOT do well under this situation since the scheme fails to handle the low detection rate case. In fact, it hurts the traffic flow by increasing the waiting time by 100%. However, the algorithm obtained by Reinforcement learning of system 110 according to the present invention does not have this problem. A continuous trend is observed during the whole transition of detection rate. In fact, the present invention provides that during the whole process, the average waiting time stays low and stable. This means, unlike DSRC-ATL, which can only solve the transition problem in sparse to medium flows, the reinforcement learning algorithm of system 110 can completely solve the transition of the detection rate for all traffic arrival rates, even when arrival rate is dense.

Another interesting finding is that the average waiting time of reinforcement learning stays stable during the transition of detection rate. This agrees with the intuition that when the arrival rate is high, the car arrival can be treated as a flow, where the detection of each particular arrival becomes less important than the whole flow quality. Therefore, in this case, the detection rate of vehicles will not have a major impact on the choice the optimal strategy. However, reinforcement learning of system 110 still figures out the optimal strategy, though this is a very different case from sparse and medium car flow. This means that a reinforcement learning based algorithm of the apparatus 110 with partial vehicle detection according to the present invention can correctly leverage the arrivals of every vehicle together with the traffic flow property, and can handle the situation over all types of car flows, from sparse to dense.

Performance for Multiple Intersections

The results mentioned above show the agent's performance over a single intersection 10. In multiple intersection case, when the agents 110 are distributed trained, the present invention illustrates that the training of one agent 110 doesn't affect the convergence of other agents 110.

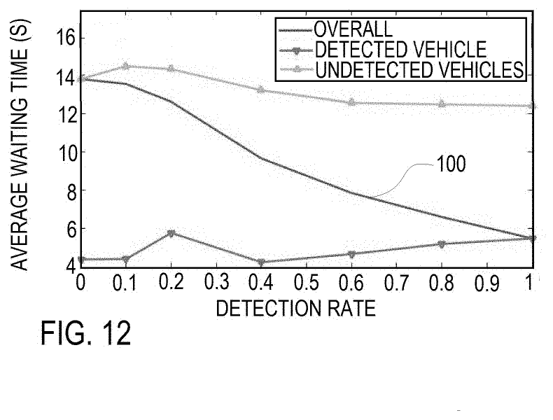

The present invention was implemented in a scenario of five agents trained simultaneously on a 5×1 Manhattan Grid. FIG. 12 shows the performance of the 5×1 grid, and this performance is very similar as the case shown in FIG. 9. The Car flows are set using an ‘arterial’ setting where the artery's arrival rate is 0.1 on both directions and all the other approaches have an arrival rate of 0.02. The trends in the two figures are similar. This consistence provides strong evidence that the present invention is able to manage the traffic with the properties discussed before.

These results show an improvement in terms of waiting time and queue length experienced at an intersection. Furthermore, there is an asymptotically improving result with an increase in the penetration rate of DSRC-equipped or detected vehicles.

Considering the information received from DSRC radios and computational resources required at each intersection, the invention proposes a compact state representation, which can be trained with a neural network with multiple hidden layers. Furthermore, performance of the trained agent 110 is compared with other traffic optimization algorithms as well as fixed time interval traffic light in the full observation case to see the effectiveness of the proposed reinforcement learning algorithm. Finally, the agent 110 is trained under different penetration rates to handle hidden cars to see the capability of the agent under partial detection scenarios and to compare it with other smart traffic light algorithms.

In this methodology, reinforcement learning, more specifically, deep Q learning for traffic control with partial detection of vehicles is utilized. The results obtained show that reinforcement learning is effective in optimizing traffic control problem under partial detection scenarios. This will be beneficial to traffic control systems using DSRC technology (as well as other possible communications technologies, such as WiFi, Bluetooth, RFID, cellular systems, and Cloud Computing, and other technologies)

The numerical results on a single intersection 10 with sparse, medium, and dense arrival rates suggest that reinforcement learning for system 110 is able to handle all kinds of traffic flow. Although the optimization of traffic on sparse arrival and dense arrival are, in general, very different, results show that reinforcement learning of system 110 is able to leverage the ‘particle’ property of the vehicle flow, as well as the ‘liquid’ property, thus providing a very powerful overall optimization scheme.

The present invention has shown promising results for single agent case that were extended later to 5 intersections shown in FIG. 12. It may be noted that one difficulty of multi-agent case (say a 15-20 agent case on an arterial road) is that the car arrival distribution will no longer be a Poisson process. However, with the help of DSRC radios, traffic lights will be able to communicate with each other and designing such a system will significantly improve the performance of the traffic control systems.

The present invention provides an efficient and effective method of using Artificial Intelligence (AI) for traffic control via software agents. The invention provides for using AI as a viable approach for optimizing the performance of vehicles approaching an intersection 10 via software agents 110 which are trained in an offline manner for an extremely large number of possible scenarios that could be encountered at every intersection 10 equipped with a traffic light 140 and optimizing the phase split to maximize the performance of vehicles 14, 16 at that intersection 10.

The invention provides a reinforcement learning (RL) based traffic control system 110 for implementing an intelligent traffic control apparatus 100 which can function when only a small portion of vehicles 14 equipped with On-Board Units (transceivers) are detected

The partially detected traffic system 110 disclosed in this application can be based on DSRC, Wifi, RFID, Bluetooth (especially BLE 5.0), UWB technologies, or could be V2C-based (Google Map, Apple Map, Baidu Map, etc.) traffic systems, or combinations thereof.

In the above examples are RL solving the traffic network as a distributed system without communications between agents as specific embodiments; however, the same methodology and approach can also be used in centralized systems and distributed systems with communications between agents 110. Those embodiments are also covered with the invention disclosed in this application

While this is an example of a template based system, the same methodology can also apply to a template-free scheme by taking time into the consideration

While as a specific implementation a simple network is disclosed as an illustrative example, it should be understood that the disclosed network design approach can also be applied to more complicated networks, such as RNN and dilated CNN, to achieve better performance.

While the disclosed invention is shown to work and provide significant performance benefits at a single intersection 10 and subsequently on a 1×5 arterial road with 5 intersections, it is understood that the developed methods and systems are also applicable to much larger urban areas, such as a 30×30 Manhattan Grid in downtown areas of a large city.

The training could further include incorporation of the pedestrian walkways, adding a state in which all laves are blocked.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment. Various modifications of the present invention may be made without departing from the spirit and scope thereof. The scope of the present invention is intended to be defined by the appended claims and equivalents thereto.

What is claimed is:

1. A method of implementing an intelligent traffic control apparatus comprising the steps of:
Providing a traffic control apparatus with a reinforcement learning based control system for a given traffic location;
Training the reinforcement based control system for the given traffic location on a simulator that simulates the given traffic location in a training environment, wherein the reinforcement learning based control system receives only partial traffic detection in the training environment on the simulator;
Coupling the reinforcement learning based control system to the traffic control apparatus at the given traffic location after training.

2. The method of implementing an intelligent traffic control apparatus according to claim 1, wherein the reinforcement learning based control system detects at least about 5% of the traffic in the training environment on the simulator.

3. The method of implementing an intelligent traffic control apparatus according to claim 2, wherein the reinforcement learning based control system detects up to about 80% of the traffic in the training environment on the simulator.

4. The method of implementing an intelligent traffic control apparatus according to claim 2, wherein the reinforcement learning based control system detects up to about 60% of the traffic in the training environment on the simulator.

5. The method of implementing an intelligent traffic control apparatus according to claim 3, wherein the reinforcement learning based control system includes an absolute minimum and maximum phase time.

6. The method of implementing an intelligent traffic control apparatus according to claim 3, wherein following coupling the reinforcement learning based control system to the traffic control apparatus at the given traffic location after training the reinforcement learning based control system maintains a control algorithm developed in the training.

7. The method of implementing an intelligent traffic control apparatus according to claim 3, wherein the reinforcement learning based control system controls the traffic control apparatus at the given traffic location based only on the traffic location's traffic condition and optional minimums and maximum phase times.

8. The method of implementing an intelligent traffic control apparatus according to claim 3, wherein the reinforcement learning based control system of the traffic control apparatus at the given traffic location is coupled to at least one other reinforcement learning based control system of a traffic control apparatus at another traffic location.

9. The method of implementing an intelligent traffic control apparatus according to claim 3, wherein the reinforcement learning based control system is associated with multiple traffic control apparatus at several given locations wherein the training of the reinforcement based control system is for the multiple traffic locations on a simulator and wherein the coupling of the reinforcement learning based control system is to the multiple traffic control apparatus at the multiple traffic location after training.

10. The method of implementing an intelligent traffic control apparatus according to claim 3, wherein the reinforcement learning based control system is a Deep Q-Network.

11. An intelligent traffic control apparatus implemented according to the method of claim 1.

12. An intelligent traffic control apparatus comprising:
A traffic control apparatus for a given traffic location; and
A reinforcement learning based control system coupled to the traffic control apparatus at the given traffic location, where the reinforcement based control system is trained for the given traffic location on a simulator that simulates the given traffic location in a training environment, and wherein the reinforcement learning based control system receives only partial traffic detection in the training environment on the simulator.

13. The intelligent traffic control apparatus according to claim 12, wherein the reinforcement learning based control system detects at least about 5% of the traffic in the training environment on the simulator.

14. The intelligent traffic control apparatus according to claim 13, wherein the reinforcement learning based control system detects up to about 80% of the traffic in the training environment on the simulator.

15. The intelligent traffic control apparatus according to claim 14, wherein the reinforcement learning based control system detects up to about 60% of the traffic in the training environment on the simulator.

16. The intelligent traffic control apparatus according to claim 14, wherein the reinforcement learning based control system includes an absolute minimum and maximum phase time.

17. The intelligent traffic control apparatus according to claim 14, wherein following coupling the reinforcement learning based control system to the traffic control apparatus at the given traffic location after training the reinforcement learning based control system maintains a control algorithm developed in the training.

18. The intelligent traffic control apparatus according to claim 14, where the reinforcement learning based control system of the traffic control apparatus at the given traffic location is coupled to at least one other reinforcement learning based control system of a traffic control apparatus at another traffic location.

19. The intelligent traffic control apparatus according to claim 14, where the reinforcement learning based control system is associated with multiple traffic control apparatus at several given locations wherein the training of the reinforcement based control system is for the multiple traffic locations on a simulator and wherein the reinforcement learning based control system is coupled to the multiple traffic control apparatus at the multiple traffic location after training.

20. The intelligent traffic control apparatus according to claim 14, where the reinforcement learning based control system is a Deep Q-Network.
